(19) United States
(12) Patent Application Publication
(10) Pub. No.: US 2026/0349746 A1
(43) Pub. Date: Nov. 5, 2026

(54) Server Management Method, Device and Apparatus, Non-Volatile Readable Storage Medium and Electronic Device

(71) Applicant: SUZHOU METABRAIN INTELLIGENT TECHNOLOGY CO., LTD., Suzhou, Jiangsu (CN)

(72) Inventors: Chaofan CHEN, Suzhou, Jiangsu (CN); Fengming ZHAO, Suzhou, Jiangsu (CN); Zhi JI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/115,763

(22) PCT Filed: Jun. 21, 2024
(86) PCT No.: PCT/CN2024/100762

§ 371 Date: Mar. 26, 2025

(30) Foreign Application Priority Data
Oct. 9, 2023 (CN) 202311300078.0

(51) Int. Cl. G06F 9/4401

(52) U.S. Cl. CPC G06F 9/441

(57) ABSTRACT

Embodiments of the present application provide a server management method, device and apparatus, a non-volatile readable storage medium, and an electronic device. The method includes: sending a target command to a target hardware partition via a first hardware interface of a first operating system, wherein a plurality of hardware partitions are divided on a server host, the plurality of hardware partitions include the target hardware partition, the first operating system and a plurality of second operating systems are deployed on a server management device, the plurality of hardware partitions are in one-to-one correspondence with the plurality of second operating systems, and the second operating systems are configured to manage the corresponding hardware partitions; receiving, via the first hardware interface, target data returned by the target hardware partition in response to the target command; and sending the target data to a target operating system via the first operating system. By means of the present application, the problem of relatively low server management efficiency is solved, and thus the effect of improving the server management efficiency is achieved.

### CROSS-REFERENCE TO RELATED APPLICATION

The present disclosure claims priority to Chinese Patent Application 2023113000780, filed in the China National Intellectual Property Administration (CNIPA) on Oct. 9, 2023, and entitled “Server Management Method, Device and Apparatus, Non-Volatile Readable Storage Medium and Electronic Device”, which is incorporated herein by reference in its entirety.

### TECHNICAL FIELD

Embodiments of the present application relate to the field of computers, and in particular to a server management method, device and apparatus, a non-volatile readable storage medium, and an electronic device.

### BACKGROUND

With the rapid development of the semiconductor industry and the integrated circuit technology, a processor has become an important computing unit in the fields of cloud computing, artificial intelligence, big data, and the like. In order to shorten the service processing delay of the processor, the technology of hardware partitions of computing resources, such as a Central Processing Unit (CPU) of a general-purpose host system, has been born at the right moment; and in order to ensure the stable operation of a hardware partition system of a server, the server must have a powerful fault monitoring and management function, a server in the prior art usually implements the acquisition of temperature of the CPU and the collection of information of a key register via an Management Engine (ME) in a Platform Controller Hub (PCH), and then sends these pieces of data to a server management device for further processing. However, the ME itself undertakes a plurality of complex tasks of server management, and there are often cases in which the acquisition of the temperature of the CPU and the collection of the register are interrupted by other tasks; and meanwhile, when a system crash occurs in the server, the ME is also likely to be affected and unable to work, resulting in a reduction in the management and monitoring capability and efficiency of each hardware partition system.

In view of problems in the related art such as relatively low server management efficiency, an effective solution has not been proposed yet.

### SUMMARY

Embodiments of the present application provide a server management method, device and apparatus, a non-volatile readable storage medium, and an electronic device, so as to at least resolve the problem of relatively low server management efficiency in the related art.

According to a first aspect of the embodiments of the present application, a server management method is provided, including:
sending a target command to a target hardware partition via a first hardware interface of a first operating system, wherein a plurality of hardware partitions are divided on a server host, the plurality of hardware partitions include the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
receiving, via the first hardware interface, target data returned by the target hardware partition in response to the target command; and
sending the target data the target operating system via the first operating system.

In an exemplary embodiment, sending the target command to the target hardware partition via the first hardware interface of the first operating system includes: acquiring the target command from the target operating system via the first operating system; and outputting the target command from the first hardware interface.

In an exemplary embodiment, outputting the target command from the first hardware interface includes: simulating a signal waveform of the target command; and outputting the signal waveform from the first hardware interface to an interface bus, wherein the interface bus is configured to connect the first hardware interface and each second hardware interface.

In an exemplary embodiment, simulating the signal waveform of the target command includes: starting a waveform simulation function of the first hardware interface, wherein interface types of the first hardware interface and the second hardware interface are different from each other, and the interface bus is a bus conforming to an interface protocol of the second hardware interface; and simulating a command waveform of the target command via the waveform simulation function, to obtain the signal waveform, wherein the signal waveform uses the address of the target hardware partition as a destination address.

In an exemplary embodiment, simulating the command waveform of the target command via the waveform simulation function includes: simulating the command waveform of a platform environment control interface command via the waveform simulation function of a general-purpose input/output interface, wherein the target command is the platform environment control interface command, the interface bus is a platform environment control interface bus, the first hardware interface includes the general-purpose input/output interface, and the second hardware interface includes a platform environment control interface.

In an exemplary embodiment, acquiring the target command from the target operating system via the first operating system includes: receiving, via the first operating system, a first interrupt request sent by the target operating system, wherein the first interrupt request is used for instructing to send, to the target hardware partition, a command meeting command codes and command parameters; and in response to the first interrupt request, acquiring, as the target command, the command codes and the command parameters, which are indicated by the first interrupt request.

In an exemplary embodiment, receiving, via the first operating system, the first interrupt request sent by the target operating system includes: receiving, via the first operating system, a target interrupt number sent by the target operating system, wherein the first interrupt request includes the target interrupt number; and determining the target hardware partition according to the target interrupt number.

In an exemplary embodiment, determining the target hardware partition according to the target interrupt number includes one of the following: searching for, from interrupt numbers and hardware partitions having a correspondence, a hardware partition corresponding to the target interrupt number as the target hardware partition; and in response to the target interrupt number, acquiring, from a first memory, first data stored by the target operating system, parsing the target operating system from the first data, and searching for, from operating systems and hardware partitions having a correspondence, a hardware partition corresponding to the target operating system as the target hardware partition.

In an exemplary embodiment, acquiring, as the target command, the command codes and the command parameters, which are indicated by the first interrupt request includes: acquiring, from a second memory, second data stored by the target operating system; and parsing the command codes and the command parameters from the second data as the target command.

In an exemplary embodiment, sending the target data to the target operating system via the first operating system includes: writing the target data into a third memory via the first operating system; and sending a second interrupt request to the target operating system via the first operating system, wherein the second interrupt request is used for instructing the target operating system to read the target data from the third memory.

In an exemplary embodiment, sending the second interrupt request to the target operating system via the first operating system includes: parsing the target operating system from the target data via the first operating system; and sending the second interrupt request to the target operating system via the first operating system.

According to a second aspect of the embodiments of the present application, a server management device is provided, including: a first operating system and a plurality of second operating systems, wherein the plurality of second operating systems are configured to manage a plurality of hardware partitions divided on a server host, the plurality of second operating systems are in one-to-one correspondence with the plurality of hardware partitions, and a first hardware interface of the first operating system is respectively connected with second hardware interfaces of each hardware partition among the plurality of hardware partitions; and the first operating system is configured to send a target command to a target hardware partition via the first hardware interface, wherein the plurality of hardware partitions include the target hardware partition, and the target command is used for instructing the target hardware partition to respond to the management of a target operating system; receive target data returned by the target hardware partition in response to the target command; and send the target data to the target operating system.

In an exemplary embodiment, the server management device further includes an interface bus, wherein the interface bus is configured to connect the first hardware interface and each second hardware interface; and the first operating system is configured to simulate a signal waveform of the target command, and output the signal waveform to the interface bus from the first hardware interface.

In an exemplary embodiment, the first hardware interface has a waveform simulation function, interface types of the first hardware interface and the second hardware interface are different from each other, the interface bus is a bus conforming to an interface protocol of the second hardware interface, and the first operation system is configured to start the waveform simulation function of the first hardware interface, and simulate a command waveform of the target command via the waveform simulation function, to obtain the signal waveform, wherein the signal waveform uses the address of the target hardware partition as a destination address.

In an exemplary embodiment, the target command is a platform environment control interface command, the interface bus is a platform environment control interface bus, the first hardware interface includes a general-purpose input/output interface, and the second hardware interface includes a platform environment control interface, and the first operating system is configured to simulate the command waveform of the platform environment control interface command via the waveform analog function of the general-purpose input/output interface.

In an exemplary embodiment, the target operating system is configured to send a first interrupt request to the first operating system, wherein the first interrupt request is used for instructing to send, to the target hardware partition, a command meeting command codes and command parameters; and the first operating system is configured to acquire, in response to the first interrupt request and as the target command, the command codes and the command parameters, which are indicated by the first interrupt request.

In an exemplary embodiment, the server management device further includes: a first memory, wherein the target operation system is configured to send a target interrupt number to the first operating system, and store first data in the first memory; and the first operating system is configured to acquire the first data from the first memory in response to the target interrupt number, parse the target operating system from the first data, and search for, from operating systems and hardware partitions having a correspondence, a hardware partition corresponding to the target operating system as the target hardware partition.

In an exemplary embodiment, the server management device further includes: a second memory, wherein the target operation system is configured to store second data in the second memory; and the first operating system is configured to parse the command codes and the command parameters from the second data as the target command.

In an exemplary embodiment, the server management device further includes: a third memory, wherein the first operating system is configured to parse the target operating system from the target data, write the target data into the third memory, and send a second interrupt request to the target operating system; and the target operating system is configured to read the target data from the third memory in response to the second interrupt request.

According to a fifth aspect of the embodiments of the present application, an electronic device is further provided, including a memory and a processor, wherein a computer program is stored in the memory, and the processor is configured to operate the computer program, so as to execute the operations in any of the operations of the following operations:
sending a target command to a target hardware partition via a first hardware interface of a first operating system, wherein a plurality of hardware partitions are divided on a server host, the plurality of hardware partitions comprise the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
receiving, via the first hardware interface, target data returned by the target hardware partition in response to the target command; and
sending the target data the target operating system via the first operating system.

By means of the present application, the plurality of hardware partitions are divided on the server host, the corresponding hardware partitions are respectively managed on the server management device via the plurality of deployed second operating systems, in addition, the first operating system is further deployed on the server management device, the first hardware interface of the first operating system is respectively connected with the second hardware interfaces of each hardware partition among the plurality of hardware partitions, the target command used for instructing the target hardware partition to respond to the management of the target operating system is sent to the target hardware partition among the plurality of hardware partitions via the first hardware interface of the first operating system, the target data returned by the target hardware partition in response to the target command is received via the first hardware interface, and then the target data is sent to the target operation system via the first operating system, that is, it is not necessary to configure a large number of hardware interfaces on the server management device, it is also not necessary to develop or adjust the hardware structure of the server management device to handle the plurality of hardware partitions of the server host, and the target command may be sent via the first operating system, so that the target hardware partition may respond to the management of the target operation system, therefore the problem of relatively low server management efficiency may be solved, and the effect of improving the server management efficiency may be achieved.

### BRIEF DESCRIPTION OF THE DRAWINGS

FIG. 1 is a block diagram of a hardware structure of a mobile terminal of a server management method according to an embodiment of the present application;

FIG. 2 is a flowchart of a server management method according to an embodiment of the present application;

FIG. 3 is a first schematic diagram of a target command according to an embodiment of the present application;

FIG. 4 is a second schematic diagram of a target command according to an embodiment of the present application;

FIG. 5 is a schematic diagram of a server management process according to an embodiment of the present application;

FIG. 6 is a schematic diagram of a working process of a co-processor according to an embodiment of the present application;

FIG. 7 is a schematic diagram of a server management method according to an embodiment of the present application;

FIG. 8 is a schematic diagram of a server management device according to an embodiment of the present application; and

FIG. 9 is a structural block diagram of a server management apparatus according to an embodiment of the present application.

### DETAILED DESCRIPTION OF THE EMBODIMENTS

Hereinafter, embodiments of the present application will be described in detail with reference to the drawings and in combination with the embodiments.

It should be noted that the terms “first” and “second” and the like in the specification, claims and the above drawings of the present application are used for distinguishing similar objects, and are not necessarily used for describing an optional sequence or precedence order.

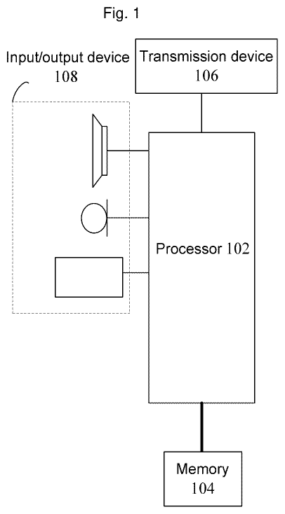

Method embodiments provided in the embodiments of the present application may be executed in a mobile terminal, a computer terminal, or a similar computing apparatus. Taking operation on the mobile terminal as an example, FIG. 1 is a block diagram of a hardware structure of a mobile terminal of a server management method according to an embodiment of the present application. As shown in FIG. 1, the mobile terminal may include one or more (only one is shown in FIG. 1) processors 102 (the processor 102 may include, but is not limited to, a processing apparatus such as a Microcontroller Unit (MCU) or a Field Programmable Gate Array (FPGA), or the like), and a memory 104, configured to store data, wherein the mobile terminal may further include a transmission device 106, configured to implement a communication function, and an input/output device 108. Those ordinary skilled in the art may understand that the structure shown in FIG. 1 is merely schematic and does not cause a limitation to the structure of the mobile terminal. For example, the mobile terminal may further include more or fewer components than those shown in FIG. 1, or have a configuration different from that shown in FIG. 1.

The memory 104 may be configured to store computer programs, for example, software programs and modules of application software, for example, a computer program corresponding to the server management method in the embodiment of the present application, and the processor 102 executes various functional applications and data processing, that is, implements the above method, by running the computer programs stored in the memory 104. The memory 104 may include a high-speed random access memory, and may further include a non-volatile memory, such as one or more magnetic storage apparatuses, a flash memory, or other non-volatile solid-state memories. In some instances, the memory 104 includes memories that are disposed remotely relative to the processor 102, and these remote memories may be connected to the mobile terminal via a network. Instances of the above network include, but are not limited to, the Internet, an intranet, a local area network, a mobile communication network, and combinations thereof.

The transmission device 106 is configured to receive or send data via a network. Optional instances of the above network may include a wireless network provided by a communication provider of the mobile terminal. In one instance, the transmission device 106 includes a Network Interface Controller (NIC for short), which may be connected with other network devices via a base station to communicate with the Internet. In one instance, the transmission device 106 may be a Radio Frequency (RF for short) module, which is configured to communicate with the Internet in a wireless manner.

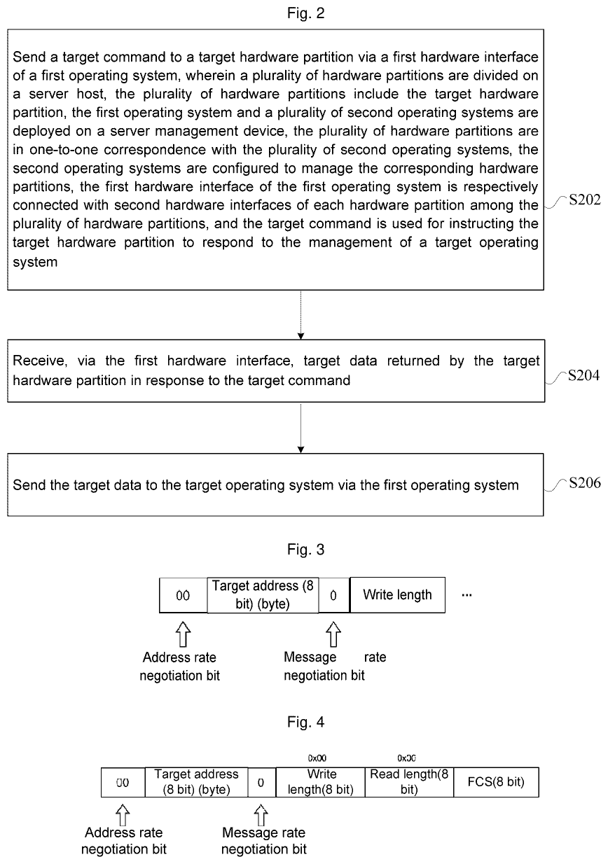

In the present embodiment, a server management method running on the mobile terminal is provided, FIG. 2 is a flowchart of a server management method according to an embodiment of the present application, and as shown in FIG. 2, the flow includes the following operations:
operation S202, sending a target command to a target hardware partition via a first hardware interface of a first operating system, wherein a plurality of hardware partitions are divided on a server host, the plurality of hardware partitions include the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
operation S204, receiving, via the first hardware interface, target data returned by the target hardware partition in response to the target command; and
operation S206, sending the target data the target operating system via the first operating system.

By means of the above operations, the plurality of hardware partitions are divided on the server host, the corresponding hardware partitions are respectively managed on the server management device via the plurality of deployed second operating systems, in addition, the first operating system is further deployed on the server management device, the first hardware interface of the first operating system is respectively connected with the second hardware interfaces of each hardware partition among the plurality of hardware partitions, the target command used for instructing the target hardware partition to respond to the management of the target operating system is sent to the target hardware partition among the plurality of hardware partitions via the first hardware interface of the first operating system, the target data returned by the target hardware partition in response to the target command is received via the first hardware interface, and then the target data is sent to the target operation system via the first operating system, that is, it is not necessary to configure a large number of hardware interfaces on the server management device, it is also not necessary to develop or adjust the hardware structure of the server management device to handle the plurality of hardware partitions of the server host, and the target command may be sent via the first operating system, so that the target hardware partition may respond to the management of the target operation system, therefore the problem of relatively low server management efficiency may be solved, and the effect of improving the server management efficiency may be achieved.

Optionally, in the present embodiment, the server management method may be, but is not limited to, applied to the server management device, and the server management device may include, but is not limited to, a device, for example: a device of an X86 architecture (the X86 architecture is a computer language instruction set executed by a microprocessor, refers to a standard number abbreviation of an intel general-purpose computer series, and also identifies a general-purpose computer instruction set, and X86 generally refers to a series of central processing unit instruction set architecture, which is based on Intel 8086 and is backward compatible), a device of an Advanced RISC Machine architecture (ARM, which is referred to as Acorn RISC Machine earlier and is a 32-bit Reduced Instruction Set Computer (RISC) processor architecture), a device of an RISC-V (risk-five, which is an open-source instruction set architecture based on the RISC principle) architecture, a device of an MIPS architecture (MIPS Architecture, which is an abbreviation of Microprocessor without interlocked piped stages architecture, is also a pun of Millions of Instructions Per Second, and is a processor architecture utilizing a RISC), etc. The method may also be, but is not limited to, applied to an embedded system, the embedded system may be an embedded heterogeneous multi-system, the heterogeneous multi-system refers to running a plurality of different operating systems (e.g., the first operating system, the second operating system, and the like) in a multi-core processor of the embedded system, and these operating systems simultaneously run in the same embedded system.

Optionally, in the present embodiment, usage scenarios of the server management method provided in the embodiment of the present application are extensive, which may include, but are not limited to, dividing the server host into a plurality of hardware partitions due to the objectives of resource isolation, performance isolation, differentiated demands, management and maintenance, and the like. Any server management scenario may use the server management method provided in the embodiment of the present application.

Optionally, in the present embodiment, the first operating system and the second operating system may be, but are not limited to, two heterogeneous or isomorphic operating systems, that is, the type of the first operating system may be the same as or different from the type of the second operating system.

It is taken as an example that the first operating system and the second operating system are heterogeneous operating systems, the first operating system and the second operating system may be operating systems having different sensitivity to a response time, for example, the sensitivity of the first operating system to the response time is higher than that of the second operating system. Or, the first operating system and the second operating system may be operating systems having different resource occupancies, for example, the resource occupancy of the first operating system for a service is less than that of the second operating system.

The first operating system and the second operating system may be, but are not limited to, two heterogeneous operating systems deployed on a processor of the embedded system, that is, embedded operating systems, the embedded operating systems may be divided into a Real-Time Operating System (RTOS) and a non-real-time operating system according to the sensitivity to the response time, the real-time operating system may include, but is not limited to, a Free Real-Time Operating System (Free RTOS) and Real Time Linux (RT Linux), and the non-real-time operating system may include, but is not limited to, Contiki Operating System (contiki), a Helix Operating System (HeliOS), Linux Operating System (Linux), etc.

It should be noted that the real-time operating system refers to that when an external event or data is generated, the real-time operating system may receive and process the external event or data at a fast enough speed, and a processing result thereof may control a production process or make a quick response to a processing system within an optional time, schedule all available resources to complete a real-time service, and control an operating system operating in coordination with all real-time services to have the characteristics of timely response and high reliability.

The embedded system is an apparatus configured to control, monitor or assist in operating machines and devices, and is a dedicated computer system. The embedded system is a dedicated computer system, which is centered on applications, based on the computer technology, have clippable software and hardware, and is applicable to strict requirements of application systems for functions, reliability, costs, volumes, power consumption, etc. When defined from the perspective of application objects, the embedded system is a combination of software and hardware, and may also include mechanical and other auxiliary apparatuses.

From the perspective of hardware, the embedded system may include, but is not limited to, hardware devices such as a processor, a memory and a peripheral circuit, and the first operating system and the second operating system run based on the processor of the embedded system. From the perspective of software, the embedded system may include, but is not limited to, an underlaying drive, an operating system, an application program, and the like, and the first operating system and the second operating system are operating systems in the embedded system.

Optionally, in the present embodiment, the server management method may be, but is not limited to, executed by the server management device, or executed by a functional module, which is disposed on the server management device and is configured to perform server management.

Optionally, in the present embodiment, the server management device may operate the first operating system and the plurality of second operating systems by means of, but not limited to, a multi-core processor in the server management device, for example, the first operating system is operated by using one processor core in the multi-core processor, and N second operating systems are respectively operated by using N processor cores. The plurality of second operating systems may independently run, but are not limited thereto, for example, two independent second operating systems are respectively configured to process different tasks without interfering with or affecting each other.

Optionally, in the present embodiment, the first operating system may run, but is not limited to, on a co-processor of the server management device, and the plurality of second operating systems may run, but are not limited to, on a central processing unit of the server management device. Therefore, the use of the co-processor is called, and the increase of devices on the server management device is also avoided.

Optionally, in the present embodiment, the co-processor may create a connection with each second operating system in the central processing unit and identify each second operating system, so as to transmit commands of different second operating systems to corresponding hardware partitions, and send data returned by the hardware partitions to the corresponding second operating systems. For example, the connection with each second operating system in the central processing unit and the identification of each second operating system may be implemented by means of, but not limited to, the registration of an inter-core interrupt, the second operating system may initiate, but is not limited to, a registration request of the inter-core interrupt to the co-processor, and in response to the registration request, the co-processor allocates an interrupt identifier, such as an interrupt number, to the second operating system, and records interrupt identifiers and second operating systems, which have a correspondence.

Optionally, in the present embodiment, the co-processor may implement a function of sending a command to the hardware partition according to the indication of the second operating system and providing the returned data to the second operating system by means of, but not limited to, starting a task and assigning a calling permission of the registered inter-core interrupt to the started task.

In the technical solution provided in the operation S202, the first operating system may be, but is not limited to, a real-time operating system, for example, an RTOS or RTLinux, and the like, and the second operating system may be, but is not limited to, a non-real-time operating system, for example, a contiki system or a Linux system, etc.

Optionally, in the present embodiment, an interrupt request may be exchanged between the first operating system and the second operating system by using, but not limited to, an inter-core communication manner. The inter-core communication manner may be implemented by software (for example, a communication protocol, an interrupt protocol, and the like).

Optionally, in the present embodiment, the second operating system is configured to monitor and manage the hardware partition corresponding thereto, including, but not limited to, memory management, hard disk partition and file system, device driver management, peripheral device, process and thread management, network management, etc.

Optionally, in the present embodiment, the first hardware interface of the first operating system is connected with the second hardware interfaces of the plurality of hardware partitions, the communication with the hardware partitions may be implemented by means of, but not limited to, the connection between the first hardware interface and the second hardware interface. The communication may include, but is not limited to, acquiring the information of each hardware partition that has established the connection, and the information may include, but is not limited to, temperature of the CPU, power consumption, a faulty register, etc.

Optionally, in the present embodiment, the first hardware interface may be connected with the second hardware interface by means of, but not limited to, a plurality of manners, for example, performing communication by using a bus, performing communication by using an interrupt signal, and the like. The first hardware interface may include, but is not limited to, a driver interface, a terminal interface, a Direct Memory Access (DMA) interface, an Input/Output (I/O) interface, a bus interface, and the like. The second hardware interface of the hardware partition may include, but is not limited to, a bus interface, a network interface card, an Internet Small Computer System Interface (SCSI), a general-purpose Serial Bus (USB), and the like. The first hardware interface and the second hardware interface may be, but are not limited to, hardware interfaces of the same type, or may also be hardware interfaces of different types.

Optionally, in the present embodiment, the first operating system may establish the first hardware interface by means of, but not limited to, a simulation manner, for example, the first operating system simulates the first hardware interface in a software manner, and the first hardware interface is configured to provide the same or similar functions as an actual hardware device, so that the first operating system may communicate with the hardware partition in the same manner.

Optionally, in the present embodiment, the server management device may include, but is not limited to, a device of an X86 architecture, a device of an ARM architecture (Advanced RISC Machine, advanced reduced instruction set computer), a device of an RISC-V architecture (Reduced Instruction Set Computer, fifth-generation reduced instruction set architecture), a device of an MIPS architecture (Microprocessor without Interlocked Pipeline Stages), etc. The server management device may be, but is not limited to, any device that allows the operation of a plurality of operating systems in the same processor, for example, a Baseboard Management Controller (BMC) device, etc.

Optionally, in the present embodiment, the first hardware interface is configured to communicate with the target hardware partition, for example, when a command is sent to the target hardware partition via the first hardware interface, and it is indicated that the target hardware partition receives the command, a response is made to the management or operation for the target hardware partition in the command. Or, a response reply sent by the target hardware partition is received by the first hardware interface, etc.

Optionally, in the present embodiment, the target operating system may be, but is not limited to, any second operating system among the plurality of second operating systems deployed on the server management device, since the second operating system is configured to manage the hardware partition having the correspondence therewith, it is possible to determine, but is not limited to, the second operating system having a management requirement as the target operating system, and determine the hardware partition having a correspondence with the target operating system as the target hardware partition, and the target command may be sent to the target hardware partition by means of, but not limited to, the first hardware interface of the first operating system, so that the target hardware partition may accept the management of the second operating system in response to the target command.

Optionally, in the present embodiment, the target command may include, but is not limited to: a management command, graph data block acquisition command, a temperature acquisition command, reading a special model register, writing into the special model register, and the like. The target command may be, but is not limited to, generated by the first operating system, for example, the first operating system generates and issues the target command according to the requirements of the target operating system. Or, the target command may be, but is not limited to, generated by the target operating system and sent to the first operating system. The target hardware partition may respond to the target command by means of, but not limited to, a plurality of manners, for example, executing an operation indicated by the target command, sending a response signal to the first operating system, etc.

Optionally, in the present embodiment, the target command may be sent to the target hardware partition by means of, but not limited to, a plurality of manners, for example, the target command carrying a key is issued to all hardware partitions, and only the target hardware partition may parse and respond to the target command. Or, an identifier of the target hardware partition is carried in the target command, and the first hardware interface issues the target command to the target hardware partition corresponding to the identifier.

Optionally, in the present embodiment, the first operating system may be, but is not limited to, configured to instruct the target hardware partition to receive the management of the target operating system, and the second operating system may be, but is not limited to, configured to process a service, wherein the service may include, but is not limited to, management for the hardware partitions, and the like, the plurality of hardware partitions may be divided on the server host according to, but not limited to, the service to be processed by each second operating system, and then, the second operating system manages the hardware partition corresponding thereto, which may include, but is not limited to, the following manners:

acquiring an allocation result of a group of services to be allocated, wherein the allocation result is used for indicating a correspondence between the services to be allocated and the second operating systems, the services to be allocated that are allocated to one operating system are usually executed by using processing resources of the operating system, and when the volume of the services allocated to a certain operating system is too large and there are unallocated processing resources currently, the unallocated processing resources may also be allocated to the services to be allocated that are allocated to the certain operating system. Therefore, according to the allocation result of the group of services to be allocated and in combination with the resource utilization condition of the processing resources of each second operating system, a mapping table between group of services to be allocated and processing resources of the processor is generated to indicate the processing resources allocated to each service to be allocated.

Here, each service to be allocated only has a mapping relationship with a certain processor core, the same processor core may have a mapping relationship with a plurality of services to be allocated, and different services may have a mapping relationship with the same processor core by occupying different time slices of the same processor core. At the same time, the same processor core is only occupied by one service, that is, the same processor core is only configured to execute one service. Different services allocated to one operating system may determine to occupy the time slices of the same processor resource according to an allocation time, a service response speed requirement, or in other manners.

It is taken as an example that processor cores that have been scheduled to the second operating system in an eight-core processor (Core 1 to Core 8) includes a Core 1, a Core 2, a Core 3 and a Core 4, there are 6 services to be allocated, a service 1 and a service 2 are real-time services, and a service 3 to a service 6 are non-real-time services, corresponding processor cores are allocated to the 6 services, the Core 1 is allocated to the service 1, a Core 5 is allocated to the service 2, the Core 2 is allocated to the service 3, the Core 3 is allocated to a service 4, the Core 4 is allocated to a service 5, and a Core 6 is allocated to the service 6.

By means of the present embodiment, based on a correspondence between the services and the operating systems, dynamic allocation of the processing resources are performed in combination with the use conditions of the processing resources of different operating systems, so that the allocation rationality of the processing resources may be ensured.

Optionally, in the present embodiment, both the first operating system and the second operating system are deployed in the server management device, for example, the first operating system is operated by using the co-processor in the server management device, and the second operating system is operated in each core in the multi-core processor in the server management device.

Optionally, in the present embodiment, the second operating system is configured to manage the hardware partition corresponding thereto, the second operating systems running on each processor core in the multi-core processor deployed on the server management device include a Linux system 1, a Linux system 2, . . . , a Linux system N, the N Linux systems respectively monitor and manage N hardware partitions divided on the server host, for example, the Linux system 1 is configured to monitor and manage a hardware partition 1 on the server host, the Linux system 2 is configured to monitor and manage a hardware partition 2 on the server host, . . . , and the Linux system N is configured to monitor and manage a hardware partition N on the server host.

In an exemplary embodiment, the target command may be sent to the target hardware partition via the first hardware interface of the first operating system by using, but not limited to, the following manner: acquiring the target command from the target operating system via the first operating system; and outputting the target command from the first hardware interface.

Optionally, in the present embodiment, the first operating system may acquire the target command by means of, but not limited to, sending an instruction, for example, when the first operating system needs to acquire the target command, the first operating system sends, to the target operating system, an indication for instructing the target operating system to generate the target command, and receives the target command sent by the target operating system in response to the indication. Or, when the target operating system has generated the target command, the first operating system receives, via the first hardware interface, the target command generated by the target operating system, etc.

Optionally, in the present embodiment, the first hardware interface may output the target command by means of, but not limited to, a plurality of manners, for example, converting the target command into a data message for sending, converting the target command into a signal for outputting, sending the target command to a shared memory, etc.

In an exemplary embodiment, the target command may be output from the first hardware interface by using, but not limited to, the following manner: simulating a signal waveform of the target command; and outputting the signal waveform from the first hardware interface to an interface bus, wherein the interface bus is configured to connect the first hardware interface and each second hardware interface.

Optionally, in the present embodiment, the signal waveform of the target command is simulated by the first hardware interface, and the simulated signal waveform of the target command may include, but is not limited to, a sine wave, a square wave, a sawtooth wave, a triangular wave, and the like. The signal waveform of a target signal may be simulated by means of, but not limited to, a plurality of manners, for example, simulating the target signal by using devices such as a waveform generator and a function generator. The signal waveform of the target signal may be presented by using, but not limited to, devices such as an oscilloscope.

Optionally, in the present embodiment, the first hardware interface and the second hardware interface may be connected by using, but not limited to, the interface bus, and the interface bus may include, but is not limited to, a Platform Environment Control Interface (PECI) bus, a System Management Bus (SMBus), an Inter-Integrated Circuit (I2C), etc.

In an exemplary embodiment, the signal waveform of the target command may be simulated by using, but not limited to, the following manner: starting a waveform simulation function of the first hardware interface, wherein interface types of the first hardware interface and the second hardware interface are different from each other, and the interface bus is a bus conforming to an interface protocol of the second hardware interface; and simulating a command waveform of the target command via the waveform simulation function, to obtain the signal waveform, wherein the signal waveform uses the address of the target hardware partition as a destination address.

Optionally, in the present embodiment, a hardware interface having the waveform simulation function may be, but is not limited to, selected as the first hardware interface, for example, an analog input/output interface, a digital input/output interface, or the like. Or, the first hardware interface may be controlled by using, but not limited to, a programming language or a corresponding development tool, to simulate the command waveform of the target command.

Optionally, in the present embodiment, the interface types of the first hardware interface and the second hardware interface are different from each other, for example, the first hardware interface is a General-purpose input/output interface (GPIO), the second hardware interface is a PECI, and the interface bus is a PECI of the interface protocol of the second hardware interface.

Optionally, in the present embodiment, the first hardware interface outputs the signal waveform to the interface bus, the signal waveform may be transmitted to the second hardware interface by means of, but not limited to, the interface bus, and since the interface bus is the bus conforming to the interface protocol of the second hardware interface, the second hardware interface may acquire the signal waveform.

In an exemplary embodiment, the command waveform of the target command may be simulated by the waveform simulation function by using, but not limited to, the following manner: simulating the command waveform of a platform environment control interface command via the waveform simulation function of a general-purpose input/output interface, wherein the target command is the platform environment control interface command, the interface bus is a platform environment control interface bus, the first hardware interface includes the general-purpose input/output interface, and the second hardware interface includes a platform environment control interface.

Optionally, in the present embodiment, it is taken as an example that the first hardware interface is a GPIO, after obtaining the target command, the first operating system may perform analysis, but is not limited to, to obtain a plurality of pieces of logical bit information corresponding to the target command, wherein there is a sequence among the plurality of pieces of logical bit information, and the first operating system may generate a waveform signal (that is, the signal waveform of the target command) corresponding to the target command by requesting the plurality of pieces of logical bit information corresponding to the request command, so as to transmit information included in the target command to other devices via the signal waveform.

Optionally, in the present embodiment, the target command may include, but is not limited to, one or more fields, and each field may be represented by a logical bit 0 or 1, on this basis, a corresponding conversion relationship between each field and the logical bit 1 or 0 is logical bit information corresponding to the field, and when the target command corresponds to a plurality of fields, the target command corresponds to the plurality of pieces of logical bit information. In addition, each logical bit may be represented by using a combination of a high-level signal and a low-level signal, for example, the logical bit 0 may be presented by using a combination of a high-level signal of a first preset duration and a low-level signal of a second preset duration, and the logical bit 1 may be presented by using a combination of a high-level signal of the second preset duration and a low-level signal of the first preset duration, wherein the first preset duration is different from the second preset duration. On this basis, since each logical bit includes both the high-level signal and the low-level signal, each logical bit is actually represented by a segment of waveform signal (the conversion between the high-level signal and the low-level signal is presented as a waveform), and since the target command corresponds to the plurality of pieces of logical bit information, that is, corresponds to a plurality of logical bits, a hardware interface signal corresponding to the target command is a signal waveform obtained by combining the waveform signal corresponding to each piece of logical bit information.

Optionally, in the present embodiment, the target command is an interface signal conforming to the interface protocol of the second hardware interface, for example, an High Definition Multimedia Interface (HDMI) signal, an Reduced Gigabit Media Independent Interface (RGMII, parallel bus) signal, an Serial Gigabit Media Independent Interface (SGMII) (reduced gigabit media independent interface) signal, a General-Purpose Input/Output (GPIO) signal, an Serial Peripheral Interface (SPI) signal, etc.

As it may be seen from the above content, in the embodiment of the present application, the command waveform corresponding to the target command is generated by the general-purpose input/output interface, so as to achieve the technical effect of simulating and generating the hardware interface signal by using software, thereby achieving the purpose of a hardware logic design in which the first hardware interface itself does not need to have a related hardware interface signal, in this way, not only may the design difficulty of the server management device be reduced, but the design cost of the server management device may also be reduced.

In an exemplary embodiment, the target command may be acquired from the target operating system via the first operating system by using, but not limited to, the following manner: receiving, via the first operating system, a first interrupt request sent by the target operating system, wherein the first interrupt request is used for instructing to send, to the target hardware partition, a command meeting command codes and command parameters; and in response to the first interrupt request, acquiring, as the target command, the command codes and the command parameters, which are indicated by the first interrupt request.

Optionally, in the present embodiment, the command codes and the command parameters may be, but are not limited to, carried in the first interrupt request, that is, the first operating system may parse, but is not limited to, the first interrupt request to acquire the command codes and the command parameters. Or, the first interrupt request may be, but is not limited to, used for instructing the first operating system to access a shared memory space, so that the first operating system may acquire the command codes and the command parameters from the memory space.

Optionally, in the present embodiment, the first interrupt request may be transmitted between the systems by means of, but not limited to, a software protocol manner, or may also be transmitted by a hardware module. It is taken as an example that the first interrupt request is transmitted in the form of a hardware module mailbox, a mailbox channel may be established between the operating systems, and the first interrupt request is transmitted by the mailbox channel.

Optionally, in the present embodiment, the target operating system instructs, via the first interrupt request, the first operating system to acquire the target command, and the target command is used for instructing the target hardware partition to respond to the management of the target operating system. The target command may be, but is not limited to, information carried in the first interrupt request, or the first operating system is instructed by the first interrupt request to acquire the target command from a fixed address.

Optionally, in the present embodiment, the target operating system may send the first interrupt request by means of, but not limited to, the following manner: storing the command codes and the command parameters in the shared memory, the target operating system sending the first interrupt request, and when the first interrupt request is received, acquiring, from the shared memory, the command codes and the command parameters, which are indicated by the first interrupt request.

Optionally, in the present embodiment, the interaction between the first operating system and the target operating system may be implemented by means of, but not limited to, a manner of combining the shared memory with inter-core communication. The target operating system may store, but is not limited to, target access content in the shared memory on the device, and write the target access content into a target memory space corresponding to a target hardware register space in the shared memory in the manner of data, and then an inter-core interrupt (i.e., the first interrupt request) is sent to the first operating system by the target operating system, to instruct the first operating system to find the content to be accessed from the shared memory.

In an exemplary embodiment, the first interrupt request sent by the target operating system may be received via the first operating system by using, but not limited to, the following manner: receiving, via the first operating system, a target interrupt number sent by the target operating system, wherein the first interrupt request includes the target interrupt number; and determining the target hardware partition according to the target interrupt number.

Optionally, in the present embodiment, the target interrupt number may be, but is not limited to, carried in the first interrupt request, and the first operating system obtains the target interrupt number by parsing the first interrupt request sent by the target operating system.

Optionally, in the present embodiment, when the target interrupt number is received, the target hardware partition may be determined according to, but not limited to, the target interrupt number, for example, a mapping relationship between terminal numbers and hardware partitions is acquired in advance, and when the target interrupt number is received, the target hardware partition corresponding to the target interrupt number is acquired from the mapping relationship. Or, the identifier of the target hardware partition is used as the target interrupt number, and when the target interrupt number is received, the target interrupt number is parsed to obtain the target hardware partition corresponding to the target interrupt number, etc.

In an exemplary embodiment, the target hardware partition may be determined according to the target interrupt number by using, but not limited to, the following manner: searching for, from interrupt numbers and hardware partitions having a correspondence, a hardware partition corresponding to the target interrupt number as the target hardware partition.

Optionally, in the present embodiment, the interrupt numbers and the hardware partitions may have, but are not limited to, a one-to-one correspondence, a mapping relationship between the interrupt numbers and the hardware partitions may be pre-stored, but it is not limited thereto, for example, an interrupt number 1 corresponds to the hardware partition 1, an interrupt number 2 corresponds to the hardware partition 2, and so on.

In an exemplary embodiment, the target hardware partition may be determined according to the target interrupt number by using, but not limited to, the following manner: in response to the target interrupt number, acquiring, from a first memory, first data stored by the target operating system; parsing the target operating system from the first data; and searching for, from operating systems and hardware partitions having a correspondence, a hardware partition corresponding to the target operating system as the target hardware partition.

Optionally, in the present embodiment, the first memory may configure, but is not limited to, a dedicated storage location for an interaction process between the operating systems, which may be referred to as a shared memory, and the shared memory may be, but is not limited to, continuously allocated according to the operating systems, that is, each operating system corresponds to a segment of dedicated shared memory.

The information (the first data) of the shared memory corresponding to the target operating system may be carried in an interrupt request (the first interrupt request) used for requesting the first operating system to read service data from a storage space, and in response to the interrupt request, the first operating system reads the service data on the shared memory indicated by the first operating system.

In an exemplary embodiment, the first memory may include, but is not limited to, a data storage area and a metadata storage area, the data storage area may be, but is not limited to, divided into a plurality of storage units, each storage unit may be, but is not limited to, configured to store the service data, and the metadata storage area may be, but is not limited to, configured to store the size and an occupied state of each storage unit in the data storage area. In order to ensure that the first data may be written into the memory, a target virtual channel into which the first data is written needs to be idle and greater than or equal to the storage space of the length of the first data, and since the memory is divided into the metadata storage area and the data storage area, the occupied state of each storage unit recorded in the metadata storage area may be read to find out the storage unit, which is located in an idle state and may meet a data storage requirement.

Optionally, in the present embodiment, the target interrupt number may be, but is not limited to, used for instructing to acquire the first data from the first memory. The first data is stored by the first operating system, and may include, but is not limited to, a correspondence among the target operating system, operating systems and hardware partitions. The correspondence between the operating systems and the hardware partitions may be, but is not limited to, stored by the first operating system, or pre-acquired. The target hardware partition corresponding to the target operating system may be determined according to, but not limited to, the correspondence between the operating systems and the hardware partitions.

In an exemplary embodiment, the command codes and the command parameters, which are indicated by the first interrupt request, may be acquired as the target command by using, but not limited to, the following manner: acquiring, from a second memory, second data stored by the target operating system; and parsing the command codes and the command parameters from the second data as the target command.

Optionally, in the present embodiment, the target operating system stores the second data in the second memory. The second memory may be, but is not limited to, the same memory space as or a different memory space from the first memory.

Optionally, in the present embodiment, the second memory may configure, but is not limited to, a dedicated storage location for the interaction process between the operating systems, which may be referred to as a shared memory, and the shared memory may be, but is not limited to, continuously allocated according to the operating systems, that is, each operating system corresponds to a segment of dedicated shared memory.

The information (the second data) of the shared memory corresponding to the target operating system may be carried in an interrupt request (the first interrupt request) used for requesting the first operating system to read service data from a storage space, and in response to the interrupt request, the first operating system reads the service data on the shared memory indicated by the first operating system.

In an exemplary embodiment, the second memory may include, but is not limited to, a data storage area and a metadata storage area, the data storage area may be, but is not limited to, divided into a plurality of storage units, each storage unit may be, but is not limited to, configured to store the service data, and the metadata storage area may be, but is not limited to, configured to store the size and an occupied state of each storage unit in the data storage area. In order to ensure that the second data may be written into the memory, a target virtual channel into which the second data is written needs to be idle and greater than or equal to the storage space of the length of the second data, and since the memory is divided into the metadata storage area and the data storage area, the occupied state of each storage unit recorded in the metadata storage area may be read to find out the storage unit, which is located in the idle state and may meet the data storage requirement.

In an exemplary embodiment, an example of a data structure of the second data is provided. Table 1 is a data structure of the second data according to an embodiment of the present application, which is as follows:

TABLE 1

| Serial | Variable | | |
|---|---|---|---|
| number | name | Variable type | Description |
| 1 | CoreNum | unsigned char | Serial number of a core |
| | | | partition for sending data |
| 2 | WtLen | unsigned char | Write length of a |
| | | | PECI command |
| 3 | RdLen | unsigned char | Read length of the |
| | | | PECI command |
| 4 | Cmd | unsigned char | Command code of the |
| | | | PECI command |
| 5 | Para | unsigned | Write parameter of |
| | | char[30] | the PECI command |

As may be seen from Table 1, the second data stored by the target operating system may include, but is not limited to, a variable name, a variable type, and a corresponding description, which are as follows:

The variable type of the variable name CoreNum is unsigned char, which is used for representing the serial number of a core partition for sending data; the variable type of the variable name WtLen is unsigned char, which is used for representing the write length of the PECI command; the variable type of the variable name RdLen is unsigned char, which is used for representing the read length of the PECI command; the variable type of the variable name Cmd is unsigned char, which is used for representing the command code of the PECI command; and the variable type of the variable name Para is unsigned char [30], which is used for representing the write parameter of the PECI command.

In an exemplary embodiment, an example of the target command is provided. FIG. 3 is a first schematic diagram 1 of a target command according to an embodiment of the present application, as shown in FIG. 3, a command address includes command codes and command parameters, a command code 00 is used for indicating an address rate negotiation bit of the target command, that is, the address rate negotiation bit of the target command is two bits 0, and the address rate negotiation bit is used for determining a transmission rate before address information is transmitted between a Host device and a Client device of a PECI bus.

The command parameters include a target address field bit width, that is, the target address field bit width of the target command is 8 bits, and the target address field bit width is used for specifying a PECI address of the Client device.

A command code 0 is used for indicating a message rate negotiation bit of the target command, that is, the message rate negotiation bit is one bit 0, and the message rate negotiation bit is used for determining a transmission rate before message information is transmitted between the Host device and the Client device of the PECI bus.

The command parameters further include a write length field bit width of the target command, that is, the write length field bit width is 8 bits, and a write length field is used for identifying the number of subsequently written valid bytes.

Optionally, in the present embodiment, the first operating system may execute the process of acquiring the target command from the target operating system by means of, but not limited to, a communication task created in the co-processor, and execute the process of sending the target command via a created protocol simulation task.

In the technical solution provided in the operation S204, the target hardware partition returns the target data to the first hardware interface in response to the target command, and the target command may include, but is not limited to, Ping (a management command), GetDIB (a graph data block acquisition command), GetTemp (a temperature acquisition command), RdIAMSR (reading a special model register), WrIAMSR (writing into the special model register), and the like. Command formats corresponding to different commands may be different, but are not limited thereto, but the command formats of different commands include fields such as a target address and a write length.

In an exemplary embodiment, an example of the target command is provided. FIG. 4 is a second schematic diagram of a target command according to an embodiment of the present application, as shown in FIG. 4, it is taken as an example that the target command is a Ping command, the command address includes command codes and a command parameter, the command code 00 is used for indicating an address rate negotiation bit of the target command, that is, the address rate negotiation bit of the target command is two bits 0, and the address rate negotiation bit is used for determining a transmission rate before address information is transmitted between the Host device and the Client device of the PECI bus. The command parameters include a target address field bit width of 8 bits. A command code 0 is used for indicating a message rate negotiation bit of the target command, that is, the message rate negotiation bit is one bit 0, and the message rate negotiation bit is used for determining a transmission rate before message information is transmitted between the Host device and the Client device of the PECI bus. The command parameters further include a write length field bit width of the target command, a read length field and a frame check sequence of response data, and the write length field bit width, the read length field and the bit width of the response data are all 8 bits.

Optionally, in the present embodiment, the first operating system may execute the process of receiving the target data by means of, but not limited to, the protocol simulation task created in the co-processor.

In the technical solution provided in the operation S206, the first operating system may be, but is not limited to, configured to send the target data to the target operating system, for example, the first operating system writes the target data into a shared memory space to which a target operation may access. Or, the first operating system directly sends the target data to the target operating system.

In an exemplary embodiment, the target data may be sent to the target operating system via the first operating system by using, but not limited to, the following manner: writing the target data into a third memory via the first operating system; and sending a second interrupt request to the target operating system via the first operating system, wherein the second interrupt request is used for instructing the target operating system to read the target data from the third memory.

Optionally, in the present embodiment, the third memory may be, but is not limited to, a shared memory space to which both the first operating system and the second operating system may access. The third memory, the first memory and the second memory may be, but are not limited to, the same memory space or independent different memory spaces.

Optionally, in the present embodiment, the third memory may configure, but is not limited to, a dedicated storage location for the interaction process between the operating systems, which may be referred to as a shared memory, and the shared memory may be, but is not limited to, continuously allocated according to the operating systems, that is, each operating system corresponds to a segment of dedicated shared memory.

The information (the target data) of the shared memory corresponding to the target operating system may be carried in an interrupt request (the second interrupt request) used for requesting the first operating system to read service data from a storage space, and in response to the interrupt request, the target operating system reads the service data on the shared memory indicated by the target operating system.

In an exemplary embodiment, the third memory may include, but is not limited to, a data storage area and a metadata storage area, the data storage area may be, but is not limited to, divided into a plurality of storage units, each storage unit may be, but is not limited to, configured to store the service data, and the metadata storage area may be, but is not limited to, configured to store the size and an occupied state of each storage unit in the data storage area. In order to ensure that third data may be written into the memory, a target virtual channel into which the third data is written needs to be idle and greater than or equal to the storage space of the length of the third data, and since the memory is divided into the metadata storage area and the data storage area, the occupied state of each storage unit recorded in the metadata storage area may be read to find out the storage unit, which is located in the idle state and may meet the data storage requirement.

Optionally, in the present embodiment, the target operating system may be instructed to read the target data in the third memory by means of, but not limited to, sending the second interrupt request to the target operating system, etc.

In an exemplary embodiment, the second interrupt request may be sent to the target operating system via the first operating system by using, but not limited to, the following manner: parsing the target operating system from the target data via the first operating system; and sending the second interrupt request to the target operating system via the first operating system.

Optionally, in the present embodiment, when the first operating system parses the target operating system from the target data, the first operating system sends the second interrupt request to the target operating system.

Optionally, in the present embodiment, the first operating system may execute the process of sending the target data to the target operating system by means of, but not limited to, the communication task created in the co-processor.

In an exemplary embodiment, an example of a data structure of the target data is provided. Table 2 is a data structure of the target data according to an embodiment of the present application, which is as follows:

TABLE 2

| Serial | Variable | | |
|---|---|---|---|
| number | name | Variable type | Description |
| 1 | CoreNum | unsigned char | Serial number of a Core |
| | | | partition for sending data |
| 2 | FCS1 | unsigned char | Check sequence for sending data |
| 3 | Data | unsigned | Received valid data |
| | | char[30] | |
| 4 | FCS2 | unsigned char | Check sequence for receiving data |

As may be seen from Table 2, the target data parsed by the target operating system may include, but is not limited to, the variable name, the variable type and the corresponding description, the variable type of the variable name CoreNum is unsigned char, which is used for representing the serial number of a Core partition for sending data; the variable type of the variable name WtLen is unsigned char, which is used for representing the check sequence for sending data; the variable type of the variable name Data is unsigned char [30], which is used for representing the received valid data; and the variable type of the variable name FCS2 is unsigned char, which is used for representing the check sequence for receiving data.

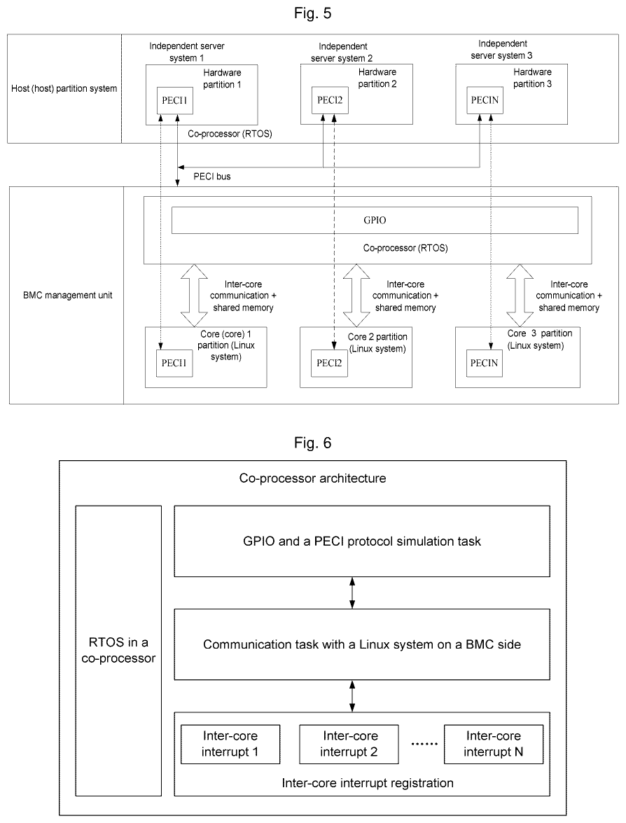

In one exemplary embodiment, an example of a server management process is provided. FIG. 5 is a schematic diagram of a server management process according to an embodiment of the present application, as shown in FIG. 5, it is taken as an example for illustration that the server host is a Host partition system, the plurality of hardware partitions divided on the server host include a hardware partition 1, a hardware partition 2 and a hardware partition 3, each hardware partition has a CPU used therein, the server management device is a BMC management unit, the first operating system deployed on the server management device is a RTOS, the BMC management unit includes a BMC multi-core processor, 3 partitions are divided in the unit of a main core and include a Core 1, a Core 2 and a Core 3, each partition independently operate the second operating system thereof, the second operating systems are in one-to-one correspondence with the hardware partitions, the second operating systems include Linux 1, Linux 2 and Linux 3, the first hardware interface is a PECI provided by the RTOS, and the second hardware interface is a PECI of each hardware partition on the server host.

The Host partition system is divided into three hardware partitions according to the number of CPU units, and each partition corresponds to one CPU processor, which is equivalent to that the entire Host partition system is split into three independent server systems. In order to implement the independent monitoring and management of each independent server system, the BMC multi-core processor in the BMC management unit is divided into three partitions in the unit of the main core.

Each independent server system of the Host partition system is provided with a PECI controller interface, and a BMC co-processor in the BMC multi-core processor is connected with all PECI controllers of the Host partition system via a GPIO, and takes the PECI bus as an interconnection bus. In addition, each partition in the BMC management unit independently operates a Linux operating system and is responsible for monitoring and managing each independent server system in the Host partition system, and a co-processor on the BMC side operates the RTOS, and is responsible for performing PECI communication with the Host partition system, and sharing communication data between Core partitions of the BMC. Each Core partition of the BMC performs data interaction with the co-processor in the form of inter-core communication and shared memory, therefore the effect of independently managing the Host partition system by one BMC management unit is achieved, which is equivalent to establishing a PECI channel from each Core partition of the BMC management unit to each hardware partition of the Host partition system.

In an exemplary embodiment, it is taken as an example that a BMC is used as the server management device, a co-processor and a multi-core processor are deployed on the BMC, the co-processor is used to operate the RTOS to serve as the first operating system, and N processor cores in the multi-core processor are used to respectively operate N Linux operating systems to serve as a plurality of second operating systems, FIG. 6 is a schematic diagram of a working process of a co-processor according to an embodiment of the present application, as shown in FIG. 6, a plurality of inter-core interrupts (an inter-core interrupt 1, an inter-core interrupt 2, . . . an inter-core interrupt N) are registered in the co-processor, the N inter-core interrupts correspond to each core, two tasks related to PECI communication are started in the co-processor, and since the RTOS operated by the co-processor is a real-time operating system, the interrupt and protocol response speed is high, thereby facilitating an improvement in the PECI rate, and reducing the working pressure of the Linux operating system.

The co-processor further operates a communication task with the Linux operating system, the communication task is responsible for monitoring the states of the inter-core interrupts, and after the corresponding interrupt number is interrupted, the communication task is responsible for accessing data of the corresponding interrupt number from the shared memory to serve as a PECI command to be sent. After the corresponding PECI command is executed, returned PECI response data is put into the corresponding shared memory according to the interrupt number in which an interrupt is generated, and the interrupt of the corresponding interrupt number is generated to notify the Linux operating system of a corresponding serial number to read related PECI data.

The co-processor further has a GPIO and a PECI protocol simulation task, and is responsible for receiving the PECI command sent by a previous task, parsing the PECI command according to the PECI protocol, controlling the corresponding GPIO to generate a PECI waveform, and sending the PECI waveform to the PECI bus. After receiving the command, a corresponding CPU makes a corresponding response according to the command, and the task parses the corresponding response into PECI data via the GPIO and sends the PECI data to the previous task. The RTOS has real-time performance, and thus may timely parse and process the GPIO waveform, therefore the pressure of the Linux operating system may be effectively reduced, and the risk of parsing failure caused by non-real-time characteristics of the Linux operating system during high-speed communication of the PECI protocol may be avoided.

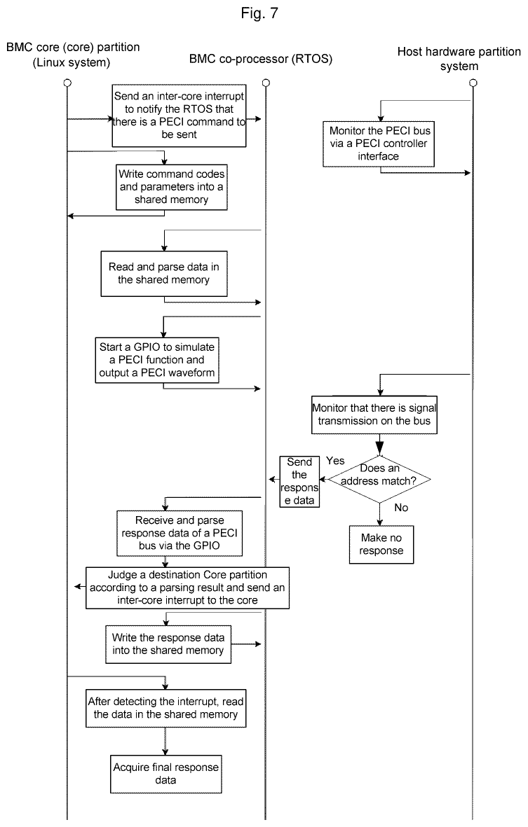

In an exemplary embodiment, an example of a server management method is provided. FIG. 7 is a schematic diagram of a server management method according to an embodiment of the present application, as shown in FIG. 7, it is taken as an example that the co-processor in the server management device operates the RTOS to serve as the first operating system, the second operating system is a Linux operating system running in the Core 1, and the target hardware partition is the hardware partition 1, and a server may be managed by means of, but not limited to, the following manner:

The Linux system of the Core 1 partition notifies the RTOS of the co-processor via an inter-core communication (e.g., by means of an inter-core interrupt signal) that there is a PECI command to be sent, and meanwhile writes information, such as the command codes and the command parameters, into the shared memory;
upon receiving an interrupt signal (the first interrupt request), the RTOS of the co-processor parses the data in the shared memory (the first memory) to acquire the PECI command to be sent (which may be, but is not limited to, the Ping command) and corresponding command parameters; and
the RTOS of the co-processor starts a GPIO (general-purpose input/output) based on the acquired command and parameters to start a PECI waveform function, so as to output a simulated waveform from the GPIO interface to the PECI bus.

The plurality of hardware partitions divided in the server host may work, but is not limited thereto, in the following manner:
each hardware partitions monitors the waveform on the PECI bus via a respective PECI controller;
each hardware partition compares whether its own PECI address is consistent with a target address on the bus, when so, receives the Ping command (the target command) and sends response data to the PECI bus, and when not, makes no response;
the RTOS of the co-processor monitors the state of the PECI bus via the GPIO interface, and caches and parses the data when detecting that there is the response data;
the RTOS of the co-processor determines a forwarding destination Core partition of the response data according to a parsing result, notifies the partition in the form of an inter-core interrupt, and meanwhile writes the response data into the shared memory; and
after receiving an inter-core interrupt signal, the Core 1 partition reads the data in the shared memory to acquire final response data corresponding to the Ping command.

By means of the descriptions of the above implementations, those skilled in the art may clearly understand that, the method according to the above embodiments may be implemented by software plus a necessary general-purpose hardware platform, and of course may also be implemented by hardware, but the former is a better implementation in many cases. Based on such an understanding, the technical solutions of the embodiments of the present application essentially or the part contributing to the prior art may be embodied in the form of a software product, and the computer software product is stored in a non-volatile readable storage medium (e.g., an Read-Only Memory (ROM)/Random Access Memory (RAM), a magnetic disk and an optical disk), and includes several instructions for enabling a terminal device (which may be a mobile phone, a computer, a server, or a network device, and the like) to execute the method in various embodiments of the present application.

In the present embodiment, a server management device is further provided, wherein the device is configured to implement the above embodiments and optional implementations, and thus details are not described again.

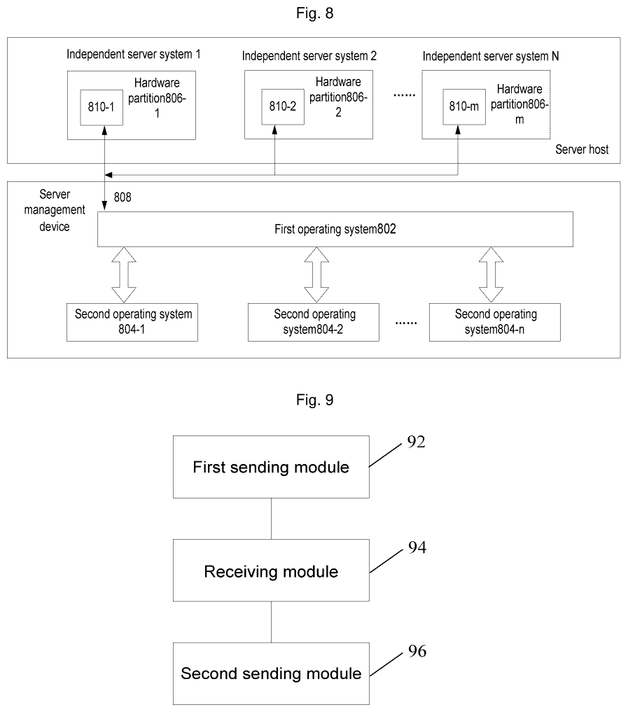

FIG. 8 is a schematic diagram of a server management device according to an embodiment of the present application, as shown in FIG. 8, the device includes: a first operating system 802 and a plurality of second operating systems (804-1 to 804-n), wherein the plurality of second operating systems (804-1 to 804-n) are configured to manage a plurality of hardware partitions (806-1 to 806-m) divided on a server host, the plurality of second operating systems are in one-to-one correspondence with the plurality of hardware partitions, and a first hardware interface 808 of the first operating system is respectively connected with second hardware interfaces (810-1 to 810-m) of each hardware partition among the plurality of hardware partitions (806-1 to 806-m); and the first operating system 802 is configured to send a target command to a target hardware partition via the first hardware interface 808, wherein the plurality of hardware partitions include the target hardware partition, and the target command is used for instructing the target hardware partition to respond to the management of a target operating system; receive target data returned by the target hardware partition in response to the target command; and send the target data to the target operating system.

By means of the device, the plurality of hardware partitions are divided on the server host, the corresponding hardware partitions are respectively managed on the server management device via the plurality of deployed second operating systems, in addition, the first operating system is further deployed on the server management device, the first hardware interface of the first operating system is respectively connected with the second hardware interfaces of each hardware partition among the plurality of hardware partitions, the target command used for instructing the target hardware partition to respond to the management of the target operating system is sent to the target hardware partition among the plurality of hardware partitions via the first hardware interface of the first operating system, the target data returned by the target hardware partition in response to the target command is received via the first hardware interface, and then the target data is sent to the target operation system via the first operating system, that is, it is not necessary to configure a large number of hardware interfaces on the server management device, it is also not necessary to develop or adjust the hardware structure of the server management device to handle the plurality of hardware partitions of the server host, and the target command may be sent via the first operating system, so that the target hardware partition may respond to the management of the target operation system, therefore the problem of relatively low server management efficiency may be solved, and the effect of improving the server management efficiency may be achieved.

In an exemplary embodiment, the server management device is further configured to: acquire the target command from the target operating system via the first operating system; and output the target command from the first hardware interface.

In an exemplary embodiment, the server management device further includes an interface bus, wherein the interface bus is configured to connect the first hardware interface and each second hardware interface; and the first operating system is configured to simulate a signal waveform of the target command, and output the signal waveform from the first hardware interface to the interface bus.

In an exemplary embodiment, the first hardware interface has a waveform simulation function, interface types of the first hardware interface and the second hardware interface are different from each other, the interface bus is a bus conforming to an interface protocol of the second hardware interface, and the first operation system is configured to start the waveform simulation function of the first hardware interface, and simulate a command waveform of the target command via the waveform simulation function, to obtain the signal waveform, wherein the signal waveform uses the address of the target hardware partition as a destination address.

In an exemplary embodiment, the target command is a platform environment control interface command, the interface bus is a platform environment control interface bus, the first hardware interface includes a general-purpose input/output interface, and the second hardware interface includes a platform environment control interface, and the first operating system is configured to simulate the command waveform of the platform environment control interface command via the waveform analog function of the general-purpose input/output interface.

In an exemplary embodiment, the target operating system is configured to send a first interrupt request to the first operating system, wherein the first interrupt request is used for instructing to send, to the target hardware partition, a command meeting command codes and command parameters; and the first operating system is configured to acquire, in response to the first interrupt request and as the target command, the command codes and the command parameters, which are indicated by the first interrupt request.

In an exemplary embodiment, the server management device further includes: a first memory, wherein the target operation system is configured to send a target interrupt number to the first operating system, and store first data in the first memory; and the first operating system is configured to acquire the first data from the first memory in response to the target interrupt number, parse the target operating system from the first data, and search for, from operating systems and hardware partitions having a correspondence, a hardware partition corresponding to the target operating system as the target hardware partition.

In an exemplary embodiment, the server management device is further configured to: receive, via the first operating system, a target interrupt number sent by the target operating system, wherein the first interrupt request includes the target interrupt number; and determine the target hardware partition according to the target interrupt number.

In an exemplary embodiment, the server management device further includes: a second memory, wherein the target operation system is configured to store second data in the second memory; and the first operating system is configured to parse the command codes and the command parameters from the second data as the target command.

In an exemplary embodiment, the server management device further includes: a third memory, wherein the first operating system is configured to parse the target operating system from the target data, write the target data into the third memory, and send a second interrupt request to the target operating system; and the target operating system is configured to read the target data from the third memory in response to the second interrupt request.

In an exemplary embodiment, the server management device is further configured to: parse the target operating system from the target data via the first operating system; and send the second interrupt request to the target operating system via the first operating system.

In the present embodiment, a server management apparatus is further provided, wherein the apparatus is configured to implement the above embodiments and optional implementations, and thus details are not described again. As used below, the term “module” may implement a combination of software and/or hardware of a predetermined function. Although the apparatus described in the following embodiments is preferably implemented in software, implementations of hardware or a combination of software and hardware are also possible and conceivable.

FIG. 9 is a structural block diagram of a server management apparatus according to an embodiment of the present application, and as shown in FIG. 9, the apparatus includes:
a first sending module 92, configured to send a target command to a target hardware partition via a first hardware interface of a first operating system, wherein a plurality of hardware partitions are divided on a server host, the plurality of hardware partitions include the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
a receiving module 94, configured to receive, via the first hardware interface, target data returned by the target hardware partition in response to the target command; and
a second sending module 96, configured to send the target data to the target operating system via the first operating system.

By means of the apparatus, the plurality of hardware partitions are divided on the server host, the corresponding hardware partitions are respectively managed on the server management device via the plurality of deployed second operating systems, in addition, the first operating system is further deployed on the server management device, the first hardware interface of the first operating system is respectively connected with the second hardware interfaces of each hardware partition among the plurality of hardware partitions, the target command used for instructing the target hardware partition to respond to the management of the target operating system is sent to the target hardware partition among the plurality of hardware partitions via the first hardware interface of the first operating system, the target data returned by the target hardware partition in response to the target command is received via the first hardware interface, and then the target data is sent to the target operation system via the first operating system, that is, it is not necessary to configure a large number of hardware interfaces on the server management device, it is also not necessary to develop or adjust the hardware structure of the server management device to handle the plurality of hardware partitions of the server host, and the target command may be sent via the first operating system, so that the target hardware partition may respond to the management of the target operation system, therefore the problem of relatively low server management efficiency may be solved, and the effect of improving the server management efficiency may be achieved.

In an exemplary embodiment, the first sending module includes:
an acquisition unit, configured to acquire the target command from the target operating system via the first operating system; and
an output unit, configured to output the target command from the first hardware interface.

In an exemplary embodiment, the output unit is configured to: simulate a signal waveform of the target command; and output the signal waveform from the first hardware interface to an interface bus, wherein the interface bus is configured to connect the first hardware interface and each second hardware interface.

In an exemplary embodiment, the output unit is further configured to: start a waveform simulation function of the first hardware interface, wherein interface types of the first hardware interface and the second hardware interface are different from each other, and the interface bus is a bus conforming to an interface protocol of the second hardware interface; and simulate a command waveform of the target command via the waveform simulation function, to obtain the signal waveform, wherein the signal waveform uses the address of the target hardware partition as a destination address.

In an exemplary embodiment, the output unit is further configured to: simulate the command waveform of a platform environment control interface command via the waveform simulation function of a general-purpose input/output interface, wherein the target command is the platform environment control interface command, the interface bus is a platform environment control interface bus, the first hardware interface includes the general-purpose input/output interface, and the second hardware interface includes a platform environment control interface.

In an exemplary embodiment, the acquisition unit is configured to: receive, via the first operating system, a first interrupt request sent by the target operating system, wherein the first interrupt request is used for instructing to send, to the target hardware partition, a command meeting command codes and command parameters; and acquire, in response to the first interrupt request and as the target command, the command codes and the command parameters, which are indicated by the first interrupt request.

In an exemplary embodiment, the acquisition unit is further configured to: receive, via the first operating system, a target interrupt number sent by the target operating system, wherein the first interrupt request includes the target interrupt number; and determine the target hardware partition according to the target interrupt number.

In an exemplary embodiment, the acquisition unit is configured to perform one of the following operations: search for, from interrupt numbers and hardware partitions having a correspondence, a hardware partition corresponding to the target interrupt number as the target hardware partition; and acquire, in response to the target interrupt number and from a first memory, first data stored by the target operating system, parse the target operating system from the first data, and search for, from operating systems and hardware partitions having a correspondence, a hardware partition corresponding to the target operating system as the target hardware partition.

In an exemplary embodiment, the acquisition unit is configured to perform one of the following operations: acquire, from a second memory, second data stored by the target operating system; and parse the command codes and the command parameters from the second data as the target command.

In an exemplary embodiment, the second sending module includes:
a writing unit, configured to write the target data into a third memory via the first operating system; and
a sending unit, configured to send a second interrupt request to the target operating system via the first operating system, wherein the second interrupt request is used for instructing the target operating system to read the target data from the third memory.

In an exemplary embodiment, the sending unit is configured to: parse the target operating system from the target data via the first operating system; and send the second interrupt request to the target operating system via the first operating system.

It should be noted that the above modules may be implemented by software or hardware, the latter may be implemented in the following manners, but are not limited thereto: the above modules are all located in the same processor; or the above modules are respectively located in different processors in any combination form.

An embodiment of the present application further provides a non-volatile readable storage medium, wherein a computer program is stored in the computer-readable storage medium, and the computer program is configured to execute the operations in any of the above method embodiments when running.

In an exemplary embodiment, the non-volatile readable storage medium may include, but is not limited to, any medium capable of storing the computer program, such as a USB flash disk, a ROM for short, a RAM for short, a mobile hard disk, a magnetic disk, or an optical disk.

An embodiment of the present application further provides an electronic device, including a memory and a processor, wherein a computer program is stored in the memory, and the processor is configured to operate the computer program, so as to execute the operations in any of the above method embodiments.

In an exemplary embodiment, the electronic device may further include a transmission device and an input/output device, wherein the transmission device is connected with the processor, and the input/output device is connected with the processor.

For optional examples in the present embodiment, reference may be made to the examples described in the above embodiments and exemplary implementations, and thus details are not described herein again in the present embodiment.

Obviously, it should be understood by those skilled in the art that, the modules or operations in the embodiments of the present application may be implemented by a general-purpose computing apparatus, may be concentrated on a single computing apparatus or distributed on a network composed of a plurality of computing apparatuses, and may also be implemented by program codes executable by the computing apparatus, therefore the modules or operations may be stored in a storage apparatus to be executed by the computing apparatus, and in some cases, the shown or described operations may be executed in a sequence different from that herein, or the operations are respectively made into various integrated circuit modules, or a plurality of modules or operations therein may be made into a single integrated circuit module for implementation. As such, the embodiments of the present application are not limited to any particular hardware and software combination.

The foregoing descriptions are only preferred embodiments of the embodiments of the present application, and are not intended to limit the embodiments of the present application, and for those skilled in the art, the embodiments of the present application may have various changes and modifications. Any modifications, equivalent replacements, improvements, and the like, made within the principles of the embodiments of the present application, shall all fall within the protection scope of the embodiments of the present application.

1. A server management method,
comprising:
sending a target command to a target hardware partition via a first hardware interface of a first operating system, wherein a plurality of hardware partitions are divided on a server host, the plurality of hardware partitions comprise the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
receiving, via the first hardware interface, target data returned by the target hardware partition in response to the target command; and
sending the target data the target operating system via the first operating system.

2. The method according to claim 1, wherein,
sending the target command to the target hardware partition via the first hardware interface of the first operating system comprises:
acquiring the target command from the target operating system via the first operating system; and
outputting the target command from the first hardware interface.

3. The method according to claim 2, wherein,
outputting the target command from the first hardware interface comprises:
simulating a signal waveform of the target command; and
outputting the signal waveform from the first hardware interface to an interface bus, wherein the interface bus is configured to connect the first hardware interface and each second hardware interface.

4. The method according to claim 3, wherein,
simulating the signal waveform of the target command comprises:
starting a waveform simulation function of the first hardware interface, wherein interface types of the first hardware interface and the second hardware interface are different from each other, and the interface bus is a bus conforming to an interface protocol of the second hardware interface; and
simulating a command waveform of the target command via the waveform simulation function, to obtain the signal waveform, wherein the signal waveform uses the address of the target hardware partition as a destination address.

5. The method according to claim 4, wherein,
simulating the command waveform of the target command via the waveform simulation function comprises:
simulating the command waveform of a platform environment control interface command via the waveform simulation function of a general-purpose input/output interface, wherein the target command is the platform environment control interface command, the interface bus is a platform environment control interface bus, the first hardware interface comprises the general-purpose input/output interface, and the second hardware interface comprises a platform environment control interface.

6. The method according to claim 2, wherein,
acquiring the target command from the target operating system via the first operating system comprises:
receiving, via the first operating system, a first interrupt request sent by the target operating system, wherein the first interrupt request is used for instructing to send, to the target hardware partition, a command meeting command codes and command parameters; and
in response to the first interrupt request, acquiring, as the target command, the command codes and the command parameters, which are indicated by the first interrupt request.

7. The method according to claim 6, wherein,
receiving, via the first operating system, the first interrupt request sent by the target operating system comprises:
receiving, via the first operating system, a target interrupt number sent by the target operating system, wherein the first interrupt request comprises the target interrupt number; and
determining the target hardware partition according to the target interrupt number.

8. The method according to claim 7, wherein,
determining the target hardware partition according to the target interrupt number comprises one of the following:
searching for, from interrupt numbers and hardware partitions having a correspondence, a hardware partition corresponding to the target interrupt number as the target hardware partition; or
in response to the target interrupt number, acquiring, from a first memory, first data stored by the target operating system, parsing the target operating system from the first data, and searching for, from operating systems and hardware partitions having a correspondence, a hardware partition corresponding to the target operating system as the target hardware partition.

9. The method according to claim 7, wherein,
acquiring, as the target command, the command codes and the command parameters, which are indicated by the first interrupt request comprises:
acquiring, from a second memory, second data stored by the target operating system; and
parsing the command codes and the command parameters from the second data as the target command.

10. The method according to claim 1, wherein,
sending the target data to the target operating system via the first operating system comprises:
writing the target data into a third memory via the first operating system; and
sending a second interrupt request to the target operating system via the first operating system, wherein the second interrupt request is used for instructing the target operating system to read the target data from the third memory.

11. The method according to claim 10, wherein,
sending the second interrupt request to the target operating system via the first operating system comprises:
parsing the target operating system from the target data via the first operating system; and
sending the second interrupt request to the target operating system via the first operating system.

12. A server management device, comprising:
a first operating system and a plurality of second operating systems, wherein,
the plurality of second operating systems are configured to manage a plurality of hardware partitions divided on a server host, the plurality of second operating systems are in one-to-one correspondence with the plurality of hardware partitions, and a first hardware interface of the first operating system is respectively connected with second hardware interfaces of each hardware partition among the plurality of hardware partitions; and
the first operating system is configured to send a target command to a target hardware partition via the first hardware interface, wherein the plurality of hardware partitions comprise the target hardware partition, and the target command is used for instructing the target hardware partition to respond to the management of a target operating system; receive target data returned by the target hardware partition in response to the target command; and send the target data to the target operating system.

13. The device according to claim 12, wherein,
the server management device further comprises an interface bus, wherein,
the interface bus is configured to connect the first hardware interface and each second hardware interface; and
the first operating system is configured to simulate a signal waveform of the target command, and output the signal waveform to the interface bus from the first hardware interface.

14. The device according to claim 13, wherein,
the first hardware interface has a waveform simulation function, interface types of the first hardware interface and the second hardware interface are different from each other, the interface bus is a bus conforming to an interface protocol of the second hardware interface, and,
the first operation system is configured to start the waveform simulation function of the first hardware interface, and simulate a command waveform of the target command via the waveform simulation function, to obtain the signal waveform, wherein the signal waveform uses the address of the target hardware partition as a destination address.

15. The device according to claim 14, wherein,
the target command is a platform environment control interface command, the interface bus is a platform environment control interface bus, the first hardware interface comprises a general-purpose input/output interface, and the second hardware interface comprises a platform environment control interface, and,
the first operating system is configured to simulate the command waveform of the platform environment control interface command via the waveform analog function of the general-purpose input/output interface.

16. The device according to claim 12, wherein,
the target operating system is configured to send a first interrupt request to the first operating system, wherein the first interrupt request is used for instructing to send, to the target hardware partition, a command meeting command codes and command parameters; and
the first operating system is configured to acquire, in response to the first interrupt request and as the target command, the command codes and the command parameters, which are indicated by the first interrupt request.

17. The device according to claim 16, wherein,
the server management device further comprises: a first memory, wherein,
the target operation system is configured to send a target interrupt number to the first operating system, and store first data in the first memory; and
the first operating system is configured to acquire the first data from the first memory in response to the target interrupt number, parse the target operating system from the first data, and search for, from operating systems and hardware partitions having a correspondence, a hardware partition corresponding to the target operating system as the target hardware partition.

18. The device according to claim 17, wherein,
the server management device further comprises: a second memory, wherein,
the target operation system is configured to store second data in the second memory; and
the first operating system is configured to parse the command codes and the command parameters from the second data as the target command.

19. The device according to claim 12, wherein,
the server management device further comprises: a third memory, wherein,
the first operating system is configured to parse the target operating system from the target data, write the target data into the third memory, and send a second interrupt request to the target operating system; and
the target operating system is configured to read the target data from the third memory in response to the second interrupt request.

20-21. (canceled)

22. An electronic device, a memory, a processor, and a computer program stored on the memory and capable of running on the processor, wherein,
the processor, when executing the computer program, implements operations comprising:
sending a target command to a target hardware partition via a first hardware interface of a first operating system, wherein a plurality of hardware partitions are divided on a server host, the plurality of hardware partitions comprise the target hardware partition, the first operating system and a plurality of second operating systems are deployed on a server management device, the plurality of hardware partitions are in one-to-one correspondence with the plurality of second operating systems, the second operating systems are configured to manage the corresponding hardware partitions, the first hardware interface of the first operating system is respectively connected with second hardware interfaces of each hardware partition among the plurality of hardware partitions, and the target command is used for instructing the target hardware partition to respond to the management of a target operating system;
receiving, via the first hardware interface, target data returned by the target hardware partition in response to the target command; and
sending the target data the target operating system via the first operating system.
